(19) United States
(12) Patent Application Publication
(10) Pub. No.: US 2015/0360989 A1
(43) Pub. Date: Dec. 17, 2015

(54) Dispersant Enhanced Ballast Recovery

(71) Applicant: Evoqua Water Technologies LLC, Warrendale, PA (US)

(72) Inventor: Raymond G. Pepin, Westbrook, ME (US)

(21) Appl. No.: 14/765,357

(22) PCT Filed: Mar. 4, 2013
(86) PCT No.: PCT/US2013/028806

§ 371 Date: Aug. 3, 2015

Related U.S. Application Data
(60) Provisional application No. 61/760,850, filed on Feb. 5, 2013.

(51) Int. Cl. C02F 11/14; C02F 1/52

(52) U.S. Cl. CPC C02F 11/14; C02F 1/52; C02F 2303/18; C02F 2305/04

(57) ABSTRACT

Disclosed are apparatus and methods for treating wastewater. In one example there is provided a wastewater treatment system. The wastewater treatment system comprises a separation vessel including a separator inlet and a settled sludge outlet, a source of treated wastewater including a ballast material configured and arranged to introduce the treated wastewater into the separation vessel, a separator configured and arranged to separate ballast from settled sludge output from the settled sludge output of the separation vessel, a sludge conduit providing fluid communication between the settled sludge outlet and the separator, and a source of dispersant configured and arranged to introduce dispersant into the settled sludge prior to separation of the ballast from the settled sludge in the separator.

### RELATED APPLICATIONS

This application claims priority under 35 U.S.C. §119(e) to U.S. Provisional Application Ser. No. 61/760,850, titled “DISPERANT ENHANCED BALLAST RECOVERY,” filed on Feb. 5, 2013, which is herein incorporated by reference in its entirety.

### BACKGROUND

1. Field of Disclosure

Aspects and embodiments of the present disclosure are directed generally to wastewater treatment systems which utilize and recover ballast to facilitate the settling of suspended solids in a settling unit.

2. Discussion of Related Art

Various methods for the treatment of wastewater involve biological treatment of the wastewater in aerobic and/or anaerobic treatment units to reduce the total organic content and/or biological organic content of the wastewater or involve physical and/or chemical treatment of wastewater in coagulation and/or flocculation units using coagulants and/or polymers to remove the inorganic content of the wastewater. Various methods of wastewater treatment may also involve the removal of flocculated solids formed by a coagulation/flocculation process from treated wastewater. These forms of biological, physical and/or chemical treatment typically result in the formation of sludge. In some methods, the sludge is removed from the wastewater after undergoing biological, physical, and/or chemical treatment by settling in a settling unit or clarifier.

### SUMMARY

In accordance with an aspect of the present disclosure, there is provided a wastewater treatment system. The wastewater treatment system comprises a separation vessel including a separation vessel inlet and a settled sludge outlet. The separation vessel is configured to receive a biologically, physically, and/or chemically treated wastewater including a ballast material from a source of biologically, physically, and/or chemically treated wastewater. The system further includes a separator including a separator inlet and a separator outlet configured and arranged to separate at least a portion of the ballast material from a settled sludge removed from the settled sludge outlet of the separation vessel and form a separated ballast, a sludge conduit providing fluid communication between the settled sludge outlet and the separator inlet, and a source of dispersant configured and arranged to introduce to dispersant into the settled sludge prior to separation of the ballast material from the settled sludge in the separator.

In accordance with some embodiments the source of dispersant is configured and arranged to introduce dispersant into the sludge conduit.

In accordance with some embodiments the source of dispersant is configured and arranged to introduce dispersant directly into the separator.

In accordance with some embodiments the source of dispersant comprises a source of surfactant.

In accordance with some embodiments the source of dispersant comprises a source of a pH adjustment agent.

In accordance with some embodiments the source of dispersant comprises a source of acid.

In accordance with some embodiments the system further comprises a source of caustic configured to introduce a caustic into an output from the separator.

In accordance with some embodiments the system further comprises an upstream source including one of a biological, physical, and chemical treatment unit having an outlet in fluid communication with the separation vessel inlet.

In accordance with some embodiments the separator is configured and arranged to direct separated ballast from the separator outlet into the one of the biological, physical, and chemical treatment units.

In accordance with another aspect of the present disclosure, there is provided a method of treating wastewater. The method comprises introducing wastewater including a ballast material from an upstream source into a separation vessel including a separation vessel inlet and a settled sludge outlet, forming a settled sludge in the separation vessel, directing the settled sludge from an outlet of the separation vessel into an inlet of a separator configured and arranged to separate at least a portion of the ballast from settled sludge and form a separated ballast and to output the separated ballast from a separator outlet, and introducing a dispersant from a source of dispersant into the settled sludge prior to separation of the at least a portion of the ballast from the settled sludge in the separator.

In accordance with some embodiments introducing the dispersant from a source of dispersant into the settled sludge comprises introducing the dispersant into a sludge conduit fluidly connecting the settled sludge outlet of the separation vessel and the inlet of the separator.

In accordance with some embodiments introducing the dispersant from a source of dispersant into the settled sludge comprises introducing the dispersant directly into the separator.

In accordance with some embodiments introducing the dispersant from a source of dispersant into the settled sludge comprises introducing a surfactant into the settled sludge.

In accordance with some embodiments introducing the dispersant from a source of dispersant into the settled sludge comprises introducing a pH adjustment agent into the settled sludge.

In accordance with some embodiments introducing the pH adjustment agent into the settled sludge comprises introducing an acid into the settled sludge.

In accordance with some embodiments the method further comprises introducing a caustic into an output from the separator.

In accordance with some embodiments the method further comprises biologically treating the wastewater in an upstream source including a biological treatment unit having an outlet in fluid communication with the separation vessel inlet.

In accordance with some embodiments the method further comprises directing the separated ballast from the separator outlet into the one of the biological, physical, and chemical treatment unit.

In accordance with another aspect of the present disclosure, there is provided a method of facilitating the separation of ballast from a ballasted sludge. The method comprises contacting the ballasted sludge with a dispersant and separating ballast from the ballasted sludge in a separator.

In accordance with another aspect of the present disclosure, there is provided a method to reduce the energy consumption of a separator for separation of ballast from a ballasted biological, physical, or chemical floc in a ballasted flocculation process. The method comprises adding a dispersant to the ballasted biological, physical, or chemical floc, the energy consumption of the separator being reduced from the energy consumption of the separator performing separation of ballasted floc not including the dispersant.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of a fluid treatment system in accordance with aspects of the present disclosure;

FIG. 2A is a schematic of a shear mill in accordance with aspects of the present disclosure;

FIG. 2B is an illustration of a rotor and stator of the shear mill of FIG. 2A;

FIG. 3 is an illustration of an ultrasonic separator in accordance with aspects of the present disclosure;

FIG. 4 is an illustration of a centrifugal separator in accordance with aspects of the present disclosure;

FIG. 5A is an illustration of a magnetic separator in accordance with aspects of the present disclosure; and

FIG. 5B is an illustration of a magnetic separator in accordance with aspects of the present disclosure.

### DETAILED DESCRIPTION

Aspects and embodiments disclosed herein are not limited to the details of construction and the arrangement of components set forth in the following description or illustrated in the drawings. Aspects and embodiments disclosed herein are capable of other embodiments and of being practiced or of being carried out in various ways.

Some systems for the treatment of wastewater from various sources, including, for example, municipal wastewater, output wastewater from pulp and paper plants, or food factories include biological, physical, and/or chemical treatment units or vessels. The biological treatment units or vessels typically include bacteria that break down components of the wastewater, for example, organic components. The biological treatment processes in the biological treatment units or vessels may reduce the total organic content and/or biological organic content of the wastewater. Biological treatment processes often result in the formation of floc, often referred to as “sludge” which may comprise dead bacteria and byproducts of the biological treatment. In some wastewater treatment system, settling vessels or clarifiers are used to remove suspended solids, including biological, physical, and/or chemical floc (referred to herein as “floc”) and/or sludge from the wastewater subsequent to biological, physical, and/or chemical treatment. Some wastewater treatment systems additionally or alternatively use a settling vessel or clarifier to remove suspended solids from influent raw wastewater and/or tertiary treatment units utilizing chemical and/or physical treatment with coagulants and/or polymers.

Hoc may have a density close to that of water (1.0 g/cm³). Gravitational settling of floc and/or other suspended solids having a density close to that of the medium, for example, water, in which they are entrained will typically occur slowly, if at all. Settling and removal of floc in a settling vessel or clarifier may require a long retention time and thus may require that the settling vessel or clarifier be very large in size to provide an acceptable throughput.

Processes to improve the settling rate of suspended solids in a clarifier can have large impacts on the clarifier size and/or the flow rate of wastewater through the clarifier. One process which may be used to improve the settling floc is to impregnate the floc with a weighting agent or ballast, for example, magnetite (available from, for example, Quality Magnetite, LLC, Kenova, W. Va.) that will bond to the floc and form a “ballasted floc” (also referred to herein as “ballasted sludge”). The ballast may be provided in the form of small particles or as a powder with particle sizes in a range of, for example, from about 5 μm to about 100 μm in diameter, with an average diameter of about 20 μm. Different sizes of ballast may be utilized in different embodiments depending, for example, on the nature and quantity of floc and/or other suspended solids to be removed in a settling process. Magnetite has a much higher density, approximately 5.1 g/cm³, than typical floc formed in biological, physical, and/or chemical wastewater treatment methods Impregnating the floc with magnetite will thus cause the floc to settle much more rapidly than it would otherwise settle. The benefit of this process is an increase in the efficiency of the gravity clarification or settling method by reducing the time to settle the floc/magnetite combination and/or by providing for a reduction in the size of a clarifier to achieve a desired throughput.

Although magnetite may be utilized as ballast material in some aspects of the present disclosure, these aspects are not limited to the use of magnetite as ballast. Other materials, for example, sand may additionally or alternatively be used as a ballast material. Further materials which may additionally or alternatively be used as ballast materials include any materials which may be attracted to a magnetic field, for example, particles or powders comprising nickel, chromium, iron, and/or various forms of iron oxide.

In some wastewater treatment systems, once the floc has settled in the clarifier or settling vessel, the ballast is removed from the settled floc and recovered for reuse. One process for separating ballast from the floc includes the use of a mechanical shearing device. In some systems, the shearing device is connected to an electric motor and spins rapidly, loosening or breaking bonds between ballast and floc disposed within the mechanical shearing device. Recovered ballast is recycled for use in the treatment of additional wastewater. One drawback is that conventional ballast recovery systems typically comprise expensive shear devices that are maintenance-intensive and draw significant electrical power. Aspects and embodiments disclosed herein include methods and apparatus that provide for the separation of the weighting agent or ballast from floc with less energy expenditure and/or operational or capital cost than previously known methods.

In one embodiment, a dispersant is added to the settled floc from a ballasted flocculation system such as a settling unit or clarifier. The dispersant weakens the bond between the ballast and the floc by reducing the surface tension between the ballast and the floc. Because of the weakened bond, the subsequent shearing and physical separation of the ballast and the floc becomes much less challenging and therefore, more efficient. In one embodiment, the dispersant is added prior to the ballasted floc being introduced into a shear device which separates the ballast from the floc. In some embodiments, the dispersant is added directly to the shear device along with the ballasted floc. The dispersant is in some embodiments alternatively or additionally added to a ballast and floc mixture prior to the introduction of the mixture into a ballast recovery mechanism such as a hydrocyclone or magnetic drum separator. The dispersant may be added in-line, with or without mechanical mixing, prior to a ballast recovery system. Adding a dispersant greatly increases the ballast recovery efficiency of the ballast recovery device with significantly less power demand.

In one embodiment, a chemical metering pump is used to inject controlled concentrations of dispersant into a waste sludge pipe, line or tank including the ballasted floc prior to the ballasted floc being introduced into any shear mixing and/or ballast recovery device such as a magnetic recovery drum or hydrocyclone. The waste sludge pipes or lines may be fitted with a flow meter which is connected to the metering pump, for example, through a computerized controller. An operator may set a desired dispersant dosage and the system may meter the flow to maintain a constant concentration of dispersant in the waste sludge including the ballasted floc as wastewater flow through the treatment system varies. In some embodiments dispersant may be added at a rate of from about 25 gallons (95 liters) to about 200 gallons (757 liters) per million gallons (3.8 megaliters) of waste sludge (25-200 ppmv) output from a clarifier. The quantity of dispersant added to the waste sludge may vary depending on, for example, the nature and quantity of floc and/or ballast in the waste sludge and/or the type of dispersant used.

In some embodiments, the dispersant may comprise a surfactant. An example of a dispersant which may be used in various embodiments is Dispex® N40 dispersing agent from BASF Corporation. Aspects and embodiments disclosed herein are not limited to the type of dispersant used. Any dispersant that can reduce the surface tension between a ballast material and a floc or reduce the strength of adhesion of floc to ballast material may be utilized.

In another embodiment, the pH of sludge including floc can be lowered to an acidic pH, for example, to a pH of between about 2 and about 5, or in some embodiments to between about 3 and about 4, to provide for improved separation of ballast from floc. Without being bound to any particular theory, it is believed that lowering the pH of the waste sludge to a sufficient degree kills various organisms, for example, bacteria in the floc, and/or destabilizes the floc which releases the ballast material from the bacteria. The pH adjustment may involve adding a pH adjustment agent, for example, an acid such as sulfuric acid or hydrochloric acid to waste sludge including floc from a clarifier or settling vessel prior to separation of the ballast from the waste sludge. After separation, the pH of the separated sludge and/or ballast may be increased, for example, to within a range of between about 5 and about 8, and in some embodiments to within a range of between about 6 and about 8, or about 6.6, with another pH adjustment agent, for example, a caustic such as sodium hydroxide. Aspects and embodiments disclosed herein are not limited to any particular types of pH adjustment agents.

One important result of using a dispersant to facilitate the separation of ballast from ballasted floc is that the power consumption of a mechanical shearing device performing the separation operation can be reduced. With the addition of an appropriate dispersant to ballasted floc to be separated, the power consumption of a mechanical shearing device for performing the separation can be reduced anywhere from about 25% to about 97% as compared to the power consumption for performing separation of ballasted floc not including a dispersant, depending on the type of mechanical shearing device used. In one example, this would make it possible to replace a 30 HP Kady Mill (Kady International) used to separate ballast from the floc in some wastewater treatment systems with a 1 HP driven shear mixer which uses less power and is significantly less expensive.

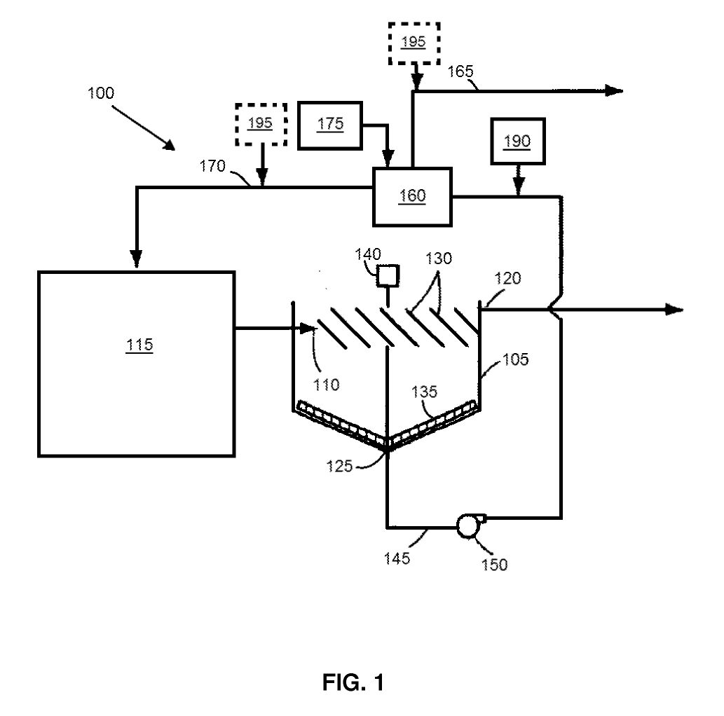

A system in accordance with one embodiment is illustrated schematically in FIG. 1, indicated generally at 100. The system includes a separation vessel 105, which in some embodiments comprises a clarifier. The separation vessel 105 receives liquid to be treated from a separation vessel inlet 110. The liquid to be treated is supplied to the separation vessel inlet 110 from an upstream source 115. In some embodiments the upstream source 115 comprises a pre-treatment or primary treatment system, for example, a biological treatment system including aerobic and/or anoxic and/or anaerobic biological treatment units. The upstream source is in other embodiments a source of raw wastewater to be treated and the separation vessel 105 may function as a primary clarifier.

In some embodiments, a ballast material, for example, magnetite is added to liquid being treated in a biological treatment vessel, for example, an aerated biological treatment vessel in the upstream source 115. Mixed liquor output from the biological treatment vessel may pass though a flocculation vessel, also in the upstream source 115 prior to being introduced into the separation vessel. Flocculation agents, for example, alum or ferric chloride may be added to the mixed liquor in the flocculation vessel to facilitate the formation of floc.

The separator 105 further includes a clarified liquid outlet 120 and a settled sludge outlet 125. In some embodiments the separator 105 further includes one or more settling plates 130 and/or a scraper 135 driven by a motor 140. The scraper 135 may facilitate directing settled sludge into the settled sludge outlet 125.

Sludge including settled ballasted floc from the settled sludge outlet travels through a sludge conduit 145 under the influence of a pump 150 and is directed into a separator 160. The separator 160 separates ballast from the ballasted floc in the sludge and forms a stream of ballast material and a stream of waste sludge. In some embodiments, however, the separator 160 may operate in a batch mode, rather than a continuous mode. The separated waste sludge is directed from the separator 160 into sludge discharge 165 from which it may be sent for downstream processing, or in some embodiments, in part recycled to a biological, physical, or chemical treatment unit which may be included in the upstream source 115. In some embodiments, ballast may be added to the waste sludge recycled to the treatment unit. Ballast separated from the sludge in the separator 160 is returned to a treatment unit, for example, an aerated biological treatment vessel in the upstream source 115 through a conduit 170. Additional ballast may also be provided from a source of ballast 175 into the separator or directly into the treatment unit. The amount of ballast directed to the upstream source 115 may vary depending on the specific configuration and desired performance of the system 100. In some embodiments all ballast recovered in the separator 160 may be introduced into a portion of the upstream source 115, for example, into a biological, physical, or chemical treatment unit.

In some embodiments the system 100 further includes a source of dispersant 190 which delivers dispersant into the sludge conduit 145 where the dispersant mixes with the sludge prior to the sludge reaching the separator 160. In some embodiments, an agitator or set of baffles may be included in the sludge conduit 145 on in an enlarged portion thereof or a chamber in fluid communication with the sludge conduit 145 to facilitate mixing of the sludge and dispersant. The dispersant facilitates separation of ballast from sludge in the separator 160. In other embodiments, the source of dispersant 190 may deliver the dispersant directly into the separator 160 to mix with the ballasted sludge prior to separation of the ballast from the floc.

In embodiments where the dispersant comprises a pH adjustment agent, for example, an acid, the acid may be introduced from the source of dispersant 190 in an amount sufficient to reduce the pH of the sludge to between about 2 and about 5, or in some embodiments to between about 3 and about 4. One or more sources of caustic 195 may be provided to introduce sufficient caustic to render the waste sludge and/or ballast in conduits 165 and 170, respectively, relatively neutral, for example with a pH of between about 5 and about 9 or between about 6 and about 8, subsequent to separation in the separator 160.

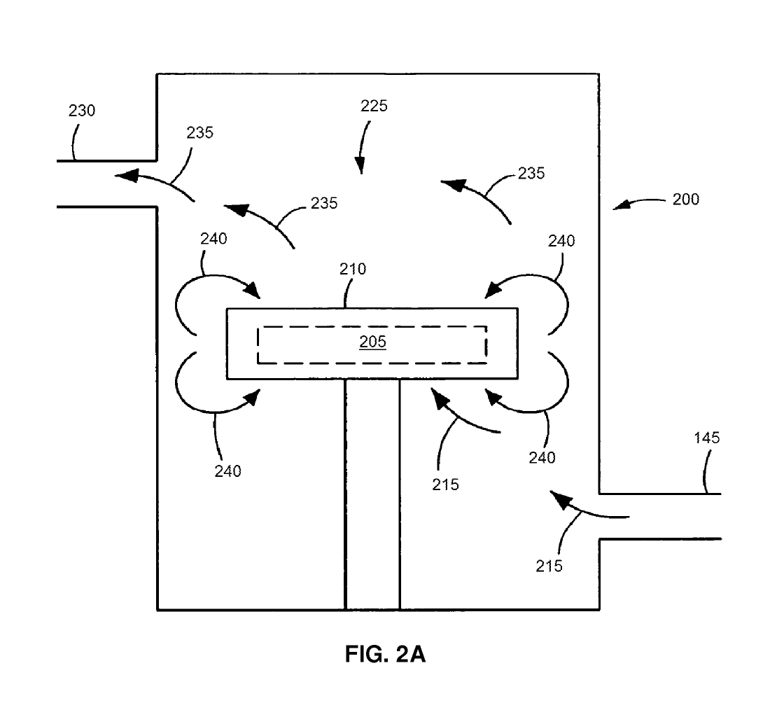

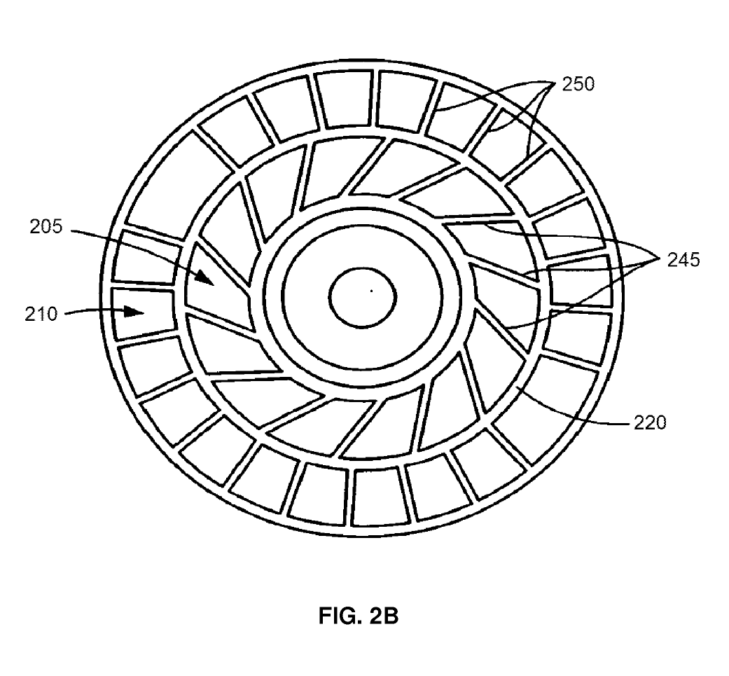

The separator 160 may include any known apparatus for separating ballast from sludge. In one example, the separator is configured as a shear mill as illustrated generally at 200 in FIGS. 2A and 2B. The shear mill 200 shears the sludge from sludge conduit 145 to separate the ballast from the sludge. The shear mill 200 may includes a rotor 205 and stator 210. In operation, the sludge from sludge conduit 145 enters the shear mill 200 and flows in the direction of arrows 215 and enters the rotor 205 and then the stator 210. The shear mill 200 may be designed such that there is a close tolerance between the rotor 205 and the stator 210, as shown at 220 in FIG. 2B. The rotor 205 is in some embodiments driven at high rotational speeds, for example, greater than about 1,000 rpm to form a mixture of ballast and substantially ballast free obliterated flocs of sludge in area 225 (FIG. 2A) of the shear mill 200. The mixture of ballast and obliterated flocs exits the shear mill 200 through conduit 230, as shown by arrows 235. The conduit 230, in some embodiments, leads to a separate subsystem of the separator 160 which divides the ballast and substantially ballast free obliterated flocs of sludge into separate streams which are output into conduits 170 and 165, respectively.

In some embodiments the rotor 205 and/or stator 210 include slots which function as a centrifugal pump to draw the sludge from above and below rotor 205 and stator 210, as shown by paths 240 in FIG. 2A. The rotor and stator then hurl the materials off the slot tips at a very high speed to break the ballasted sludge into the mixture of ballast and obliterated flocs of sludge. For example, the rotor 205 may to include slots 245, and the stator 210 may include slots 250. The slots 245 in the rotor 205 and/or the slots 250 in the stator 210 may be designed to increase shear energy to efficiently separate the ballast from the ballast containing sludge. The shear developed by the rotor 205 and stator 210 may depend on the width of slots 245 and 250, the tolerance between the rotor 205 and stator 210, and the rotor tip speed. The result is that the shear mill 200 provides a shearing effect which effectively and efficiently separates the ballast from the ballasted sludge to facilitate recovery of the ballast.

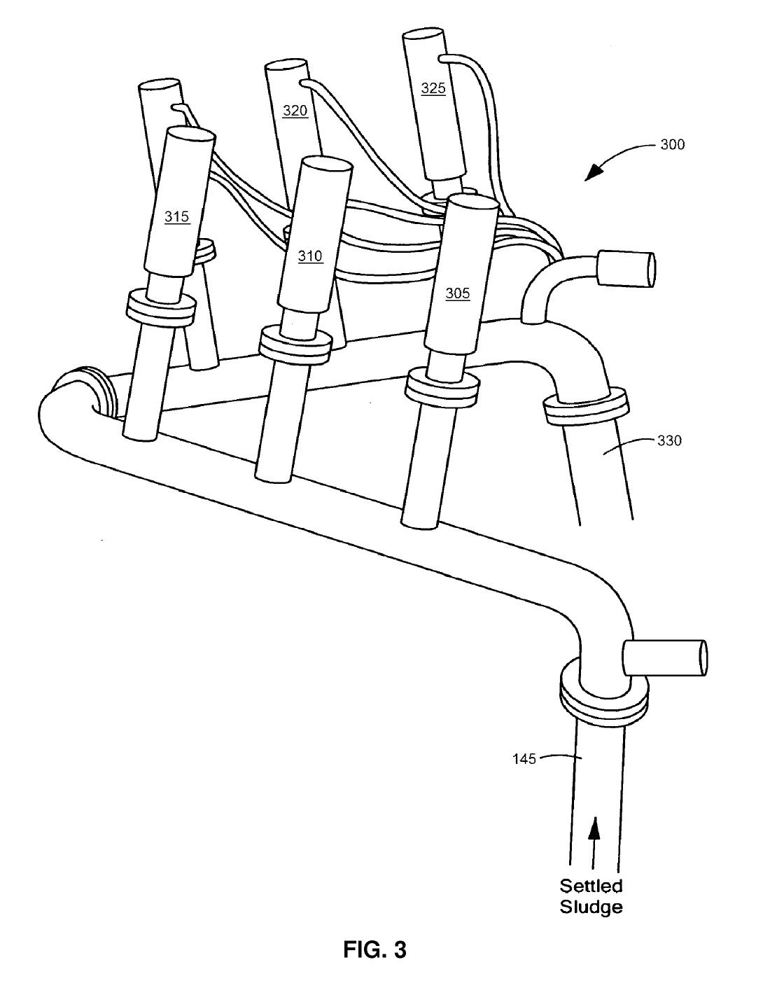

In another example, the separator 160 may be configured as an ultrasonic separator, indicated generally at 300 in FIG. 3. The ultrasonic separator 300 may include one or more ultrasonic transducers, for example, ultrasonic transducers 305, 310, 315, 320, and/or 325, which may include ultrasonic transducers available from Hielscher Ultrasonics GmbH. The ultrasonic transducers generate fluctuations of pressure and cavitation in the ballasted sludge in the sludge conduit 145. This results in microturbulences that produce a shearing effect to create a mixture of ballast and obliterated flocs of sludge to effectively separate the ballast from the ballasted sludge. The resulting mixture of ballast and obliterated flocs exits the ultrasonic separator 300 through conduit 330. The conduit 330, in some embodiments, leads to a separate subsystem of the separator 160 which divides the ballast and substantially ballast free obliterated flocs of sludge into separate streams which are output into conduits 170 and 165, respectively.

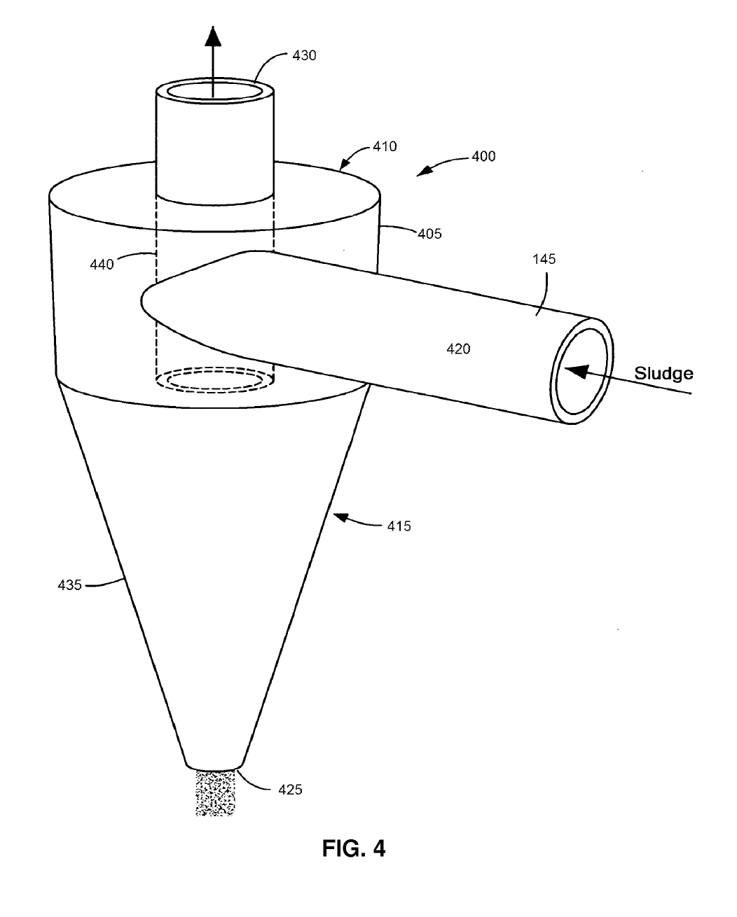

In some embodiments the mixture of ballast and obliterated flocs exiting the shear mill 200 or ultrasonic separator 300 may be divided into separate streams in a centrifugal separator, indicated generally at 400 in FIG. 4. The centrifugal separator 400 includes a cylindrical section 405 located at the top of a hydrocyclone 410 and a conical section 415 located below the cylindrical section 405. The ballasted sludge from conduit 145 is fed tangentially into the cylindrical section 405 through a port 420. A smaller exit port 425 (underflow or reject port) is located at the bottom of the conical section 415 and a larger exit port 430 (overflow or accept port) is located at the top of the cylindrical section 405.

In operation, the centrifugal force created by the tangential feed of the mixture of ballast and obliterated flocs of sludge through the port 420 causes the denser ballast to be separated from the flocs of sludge in the mixture. The separated ballast is expelled against the wall 435 of the conical section 415 and exits though the port 425 from which it may be directed into conduit 170 (FIG. 1). This effectively separates the ballast from the mixture of ballast and obliterated flocs of sludge. The less dense flocs of sludge exit via port 430 through tube 440 extending slightly into the body of the center of centrifugal separator 400 from which it may be directed into conduit 165 (FIG. 1).

In some embodiments the centrifugal separator 400 may be utilized alone, without the shear mill 200 or ultrasonic separator 300 in the separator 160.

Although as discussed above, separator 160 may include a shear mill, an ultrasonic separator, and/or a centrifugal separator, this is not a necessary limitation of embodiments disclosed herein. In other embodiments, the separator 160 may be configured as, for example, a tubular bowl, a chamber bowl, an imperforate basket, a disk stack separator, or as other forms of separation systems known by those skilled in the art.

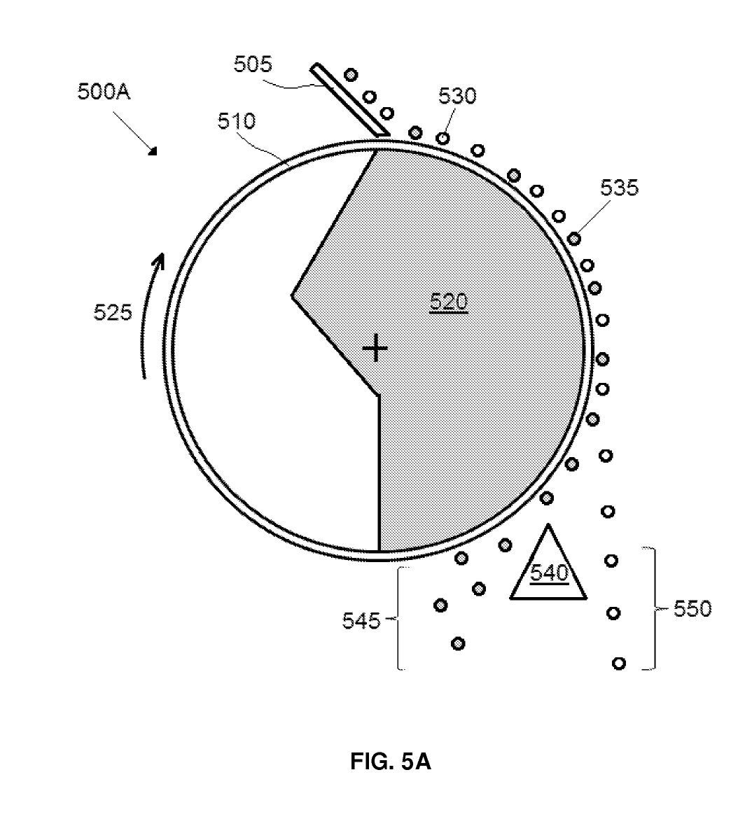

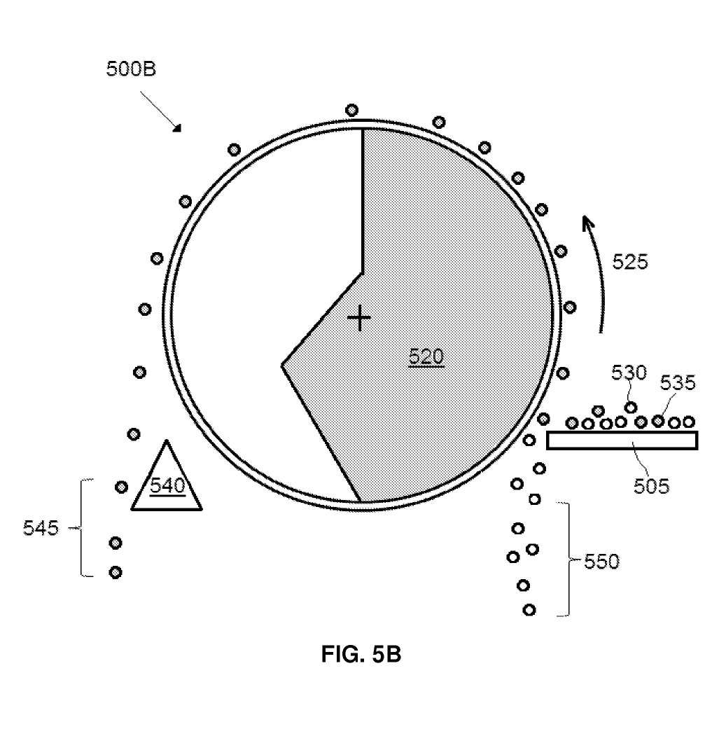

In some embodiments, the mixture of ballast and obliterated flocs of sludge exiting the shear mill 200 or ultrasonic separator 300 may be divided into separate streams in a magnetic drum separator, indicated generally at 500A in FIG. 5A. The magnetic drum separator 500A includes a drum 510 in which is disposed a magnet 520. The drum rotates in the direction of arrow 525, clockwise in this example. A mixture of ballast 535, represented by the colored circles in FIG. 5A, and obliterated flocs of sludge 530, represented by the empty circles in FIG. 5A, are introduced to the surface of the rotating drum 510 through a conduit or feed ramp 505. The ballast, when comprised of a magnetic material, for example, magnetite, adheres more strongly to the drum 510 than the obliterated flocs of sludge due to the presence of the magnet 520. The obliterated flocs of sludge will fall off of the drum, in some examples aided by centripetal force generated by the rotating drum, before the ballast. A division vane 540 may separate the ballast 535 and obliterated flocs of sludge 530 into two separate output streams 545, and 550, respectively.

In another embodiment of the magnetic separator, indicated generally at 500B in FIG. 5B, the mixture of ballast and obliterated flocs of sludge is introduced by a conduit or feed ramp 505 to a position proximate and to the side of the rotating drum 510. The ballast, when comprised of a magnetic material, for example, magnetite, adheres to the rotating drum 510 due to the presence of the magnet 520 and may be removed from the rotating drum on the opposite side from the conduit or feed ramp 505 by, for example, a scraper or division vane 540. The obliterated flocs of sludge do not adhere to the rotating drum 510 and instead drop from the end of the conduit or feed ramp 505. The result is the production of separate streams 545 and 550 of the ballast 535 and obliterated flocs of sludge 530.

The result of recovering and recycling the weighting agent as discussed above significantly reduces the operating costs of wastewater treatment system 100.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the spirit and scope of the disclosure. For example, although aspects of the present disclosure are described as used to remove floc from wastewater, these aspects may be equally applicable to the removal of any form of suspended solids, for example, inorganic suspended solids, fats, oil, or grease in a settling unit or vessel. Aspects of the wastewater treatment systems described herein may use non-biological, physical, and/or chemical treatment methods and/or biological treatment methods for the treatment of wastewater. Accordingly, the foregoing description and drawings are by way of example only.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A wastewater treatment system comprising:
a separation vessel including a separation vessel inlet and a settled sludge outlet, the separation vessel configured to receive a treated wastewater including a ballast material from a source of treated wastewater;
a separator including a separator inlet and a separator outlet configured and arranged to separate at least a portion of the ballast material from a settled sludge removed from the settled sludge outlet of the separation vessel and form a separated ballast;
a sludge conduit providing fluid communication between the settled sludge outlet and the separator inlet; and
a source of dispersant configured and arranged to introduce dispersant into the settled sludge prior to separation of the ballast material from the settled sludge in the separator.

2. The system of claim 1, wherein the source of dispersant is configured and arranged to introduce dispersant into the sludge conduit.

3. The system of claim 1, wherein the source of dispersant is configured and arranged to introduce dispersant directly into the separator.

4. The system of claim 1, wherein the source of dispersant comprises a source of surfactant.

5. The system of claim 1, wherein the source of dispersant comprises a source of a pH adjustment agent.

6. The system of claim 5, wherein the source of dispersant comprises a source of acid.

7. The system of claim 6, further comprising a source of caustic configured to introduce a caustic into an output from the separator.

8. The system of claim 1, further comprising an upstream source including a one of a biological treatment unit, a physical treatment unit, and a chemical treatment unit having an outlet in fluid communication with the separation vessel inlet.

9. The system of claim 8, wherein the separator is configured and arranged to direct separated ballast from the separator outlet into the one of the biological treatment unit, physical treatment unit, and chemical treatment unit.

10. A method of treating wastewater comprising:
introducing wastewater including a ballast material from an upstream source into a separation vessel including a separation vessel inlet and a settled sludge outlet;
forming a settled sludge in the separation vessel;
directing the settled sludge from an outlet of the separation vessel into an inlet of a separator configured and arranged to separate at least a portion of the ballast from settled sludge and form a separated ballast and to output the separated ballast from a separator outlet; and
introducing a dispersant from a source of dispersant into the settled sludge prior to separation of the at least a portion of the ballast from the settled sludge in the separator.

11. The method of claim 10, wherein introducing the dispersant from a source of dispersant into the settled sludge comprises introducing the dispersant into a sludge conduit fluidly connecting the settled sludge outlet of the separation vessel and the inlet of the separator.

12. The method of claim 10, wherein introducing the dispersant from a source of dispersant into the settled sludge comprises introducing the dispersant directly into the separator.

13. The method of claim 10, wherein introducing the dispersant from a source of dispersant into the settled sludge comprises introducing a surfactant into the settled sludge.

14. The method of claim 10, wherein introducing the dispersant from a source of dispersant into the settled sludge comprises introducing a pH adjustment agent into the settled sludge.

15. The method of claim 14, wherein introducing the pH adjustment agent into the settled sludge comprises introducing an acid into the settled sludge.

16. The method of claim 15, further comprising introducing a caustic into an output from the separator.

17. The method of claim 10, further comprising treating the wastewater in an upstream source including a treatment unit having an outlet in fluid communication with the separation vessel inlet.

18. The method of claim 10, further comprising directing the separated ballast from the separator outlet into the treatment unit.

19. A method of facilitating the separation of ballast from a ballasted sludge comprising:
contacting the ballasted sludge with a dispersant; and
separating ballast from the ballasted sludge in a separator.

20. A method to reduce the energy consumption of a separator for separation of a ballast from a ballasted floc in a ballasted flocculation process comprising adding a dispersant to the ballasted floc, the energy consumption of the separator being reduced from the energy consumption of the separator performing separation of ballasted floc not including the dispersant.
